(19) United States
(12) Patent Application Publication
(10) Pub. No.: US 2014/0057144 A1
(43) Pub. Date: Feb. 27, 2014

(54) RECHARGEABLE BATTERY PACK AND BATTERY MODULE

(71) Applicant: SAMSUNG SDI CO., LTD., Yongin-si (KR)

(72) Inventor: Seo-Hoon YANG, Yongin-si (KR)

(73) Assignee: SAMSUNG SDI CO., LTD., Yongin-si (KR)

(21) Appl. No.: 13/834,775

(22) Filed: Mar. 15, 2013

(30) Foreign Application Priority Data
Aug. 24, 2012 (KR) 10-2012-0093052

(51) Int. Cl. H01M 10/42

(52) U.S. Cl. CPC H01M 10/42
USPC 429/62; 429/82; 429/71; 429/61

(57) ABSTRACT

A battery module may include a plurality of rechargeable batteries, each of the plurality of rechargeable batteries having a terminal, a connecting member electrically connecting terminals of neighboring rechargeable batteries, and a gas supply unit that supplies inert gas to the rechargeable batteries.

### CROSS-REFERENCE TO RELATED APPLICATION

This application claims priority under 35 U.S.C. §119 to Korean Patent Application No. 10-2012-0093052 filed on Aug. 24, 2012, in the Korean Intellectual Property Office, and entitled: “Rechargeable Battery Pack And Battery Module,” the entire contents of which is hereby incorporated by reference.

### BACKGROUND

1. Field

Embodiments relate to a rechargeable battery pack and a battery module.

2. Description of the Related Art

A rechargeable battery may be repeatedly charged and discharged. A small-capacity rechargeable battery may be used for small portable electronic devices such as, e.g., mobile phones, notebook computers, camcorders, and the like, while a large-capacity rechargeable battery may be used for, e.g., a motor-driving power source for hybrid vehicles and electric vehicles.

### SUMMARY

Embodiments are directed to a battery module that may include a plurality of rechargeable batteries, each of the plurality of rechargeable batteries having a terminal, a connecting member electrically connecting terminals of neighboring rechargeable batteries, and a gas supply unit that supplies inert gas to the rechargeable batteries.

The battery module may further include a valve provided between the gas supply unit and the rechargeable batteries, the valve controlling a supply of the inert gas.

The gas supply unit may be connected to the rechargeable batteries through a gas supply pipe.

Each of the rechargeable batteries may include a case forming an enclosure and a cap plate included with the case, and the inert gas may be injected into the case.

The gas supply pipe may be installed in the cap plate.

The battery module may further include a sealing member provided between the gas supply pipe and the cap plate.

A plurality of gas supply pipes may be connected to the gas supply unit through a confluence pipe.

The battery module may further include a pump that pressurizes and supplies the inert gas, the pump being installed in the confluence pipe.

The inert gas may include at least one material selected from among the group of helium, neon, argon, krypton, xenon, radon, and nitrogen.

The battery module may further include a battery management system (BMS) connected to the valve, the battery management system controlling opening and closing of the valve.

The battery module may further include a measurer installed in each of the rechargeable batteries, and the measurer may include at least one from the group of a thermometer, a pressure gauge, and an impact detecting sensor.

The battery management system (BMS) may be connected to the measurer, and may use information provided by the measurer to control opening and closing of the valve.

The battery management system (BMS) may independently control the supply of the inert gas to a first rechargeable battery and the supply of the inert gas to a second rechargeable battery.

Embodiments are also directed to a rechargeable battery pack that may include a rechargeable battery, the rechargeable battery including a case, a gas supply unit that supplies inert gas into the case, a valve provided between the gas supply unit and the rechargeable battery, the valve controlling a supply of the inert gas, and a battery management system (BMS) that controls opening and closing of the valve.

The gas supply unit may be connected to the rechargeable battery through a gas supply pipe.

The rechargeable battery pack may further include a cap plate included with the case, wherein the gas supply pipe may be installed in the cap plate.

The rechargeable battery pack may further include a sealing member installed between the gas supply pipe and the cap plate.

The rechargeable battery pack may further include a measurer installed in the rechargeable battery, the measurer including at least one selected from among the group of a thermometer, a pressure gauge, and an impact detecting sensor.

The battery management system (BMS) may be connected to the measurer, and may use information provided by the measurer to control opening and closing of the valve.

### BRIEF DESCRIPTION OF THE DRAWINGS

Features will become apparent to those of skill in the art by describing in detail exemplary embodiments with reference to the attached drawings in which:

FIG. 1 illustrates a schematic diagram of a battery module according to a first exemplary embodiment;

FIG. 2 illustrates a perspective view of a battery module according to the first exemplary embodiment;

FIG. 3 illustrates a cross-sectional view with respect to a line of FIG. 2.

FIG. 4 illustrates a schematic diagram of a battery module according to a second exemplary embodiment; and

FIG. 5 illustrates a schematic diagram of a rechargeable battery pack according to a third exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

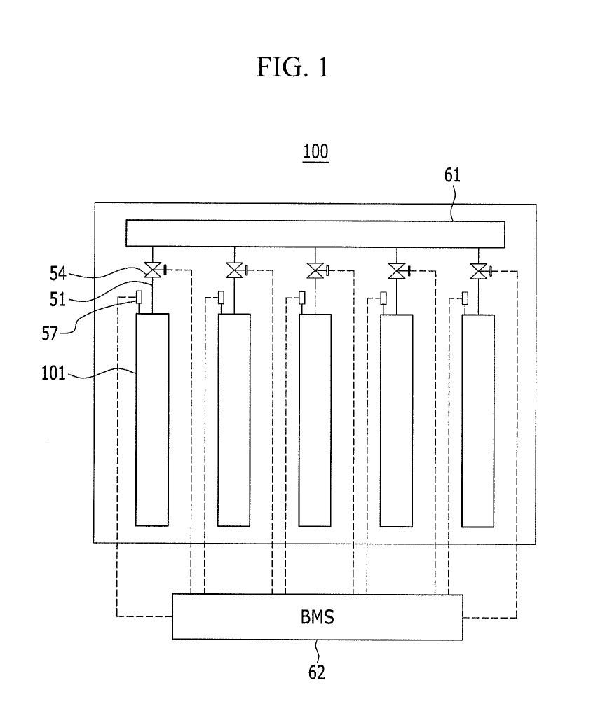

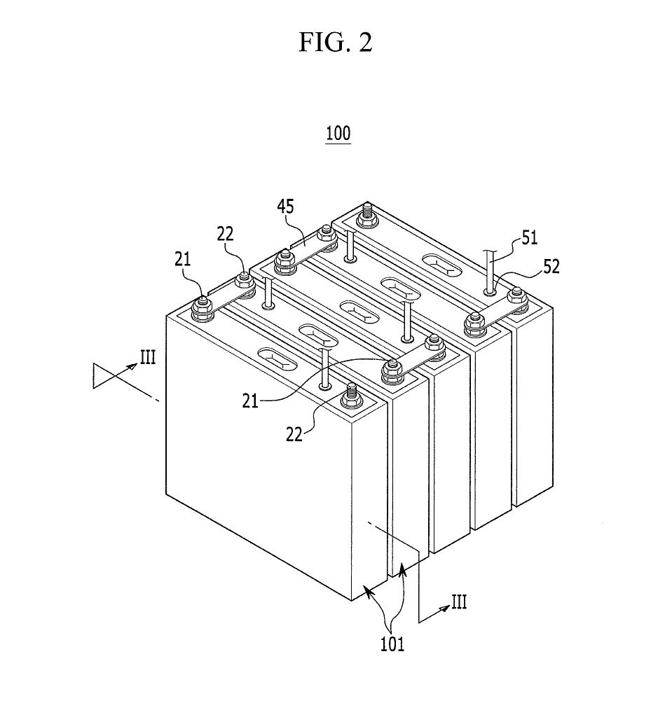

FIG. 1 illustrates a schematic diagram of a battery module according to a first exemplary embodiment, and FIG. 2 illustrates a perspective view of a battery module according to the first exemplary embodiment.

Referring to FIG. 1 and FIG. 2, a battery module 100 may include a plurality of rechargeable batteries 101 having a positive terminal 21 and a negative terminal 22, a connecting member 45 that electrically connects the rechargeable batteries 101, and a gas supply unit 61 that supplies inert gas to the rechargeable batteries 101.

In the battery module 100, the rechargeable batteries 101 may be coupled (e.g., electrically connected) in series. However, the rechargeable batteries 101 may also be coupled (e.g., electrically connected) in parallel.

The rechargeable batteries may be coupled in series by the connecting member 45, while the positive terminal 21 and the negative terminal 22 may be alternately arranged. Connecting members 45 may be combined with (e.g., electrically connected to) the positive terminal 21 and the negative terminal 22 and may be fixed by a top nut 29.

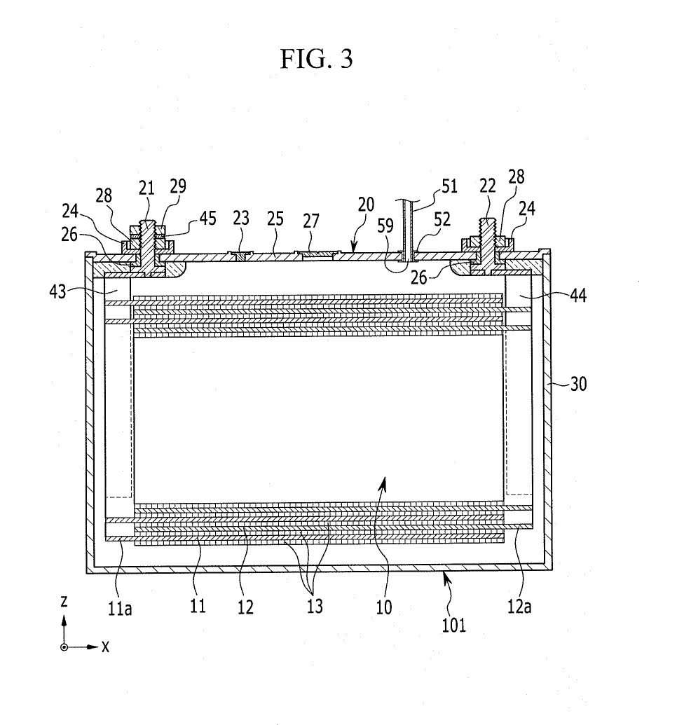

As shown in FIG. 3, a rechargeable battery 101 may include an electrode assembly 10 having a separator 13 wound and/or layered between a positive electrode 11 and a negative electrode 12, a case 30 having the electrode assembly 10 installed therein, and a cap plate 25 combined with an opening of the case 30.

The rechargeable battery 101 may be exemplified as a square-type lithium ion secondary battery, however, other suitable types of batteries may be used (e.g., a lithium polymer battery and/or a cylindrical battery).

The positive electrode 11 and the negative electrode 12 may include a coated region, which may be an area in which an active material is coated on a current collector formed of, e.g., a thin-plate metal foil, and an uncoated region in which the active material may not be coated.

A positive uncoated region 11 a may be formed at an end of a first side of the positive electrode 11 along a length direction of the positive electrode 11, and a negative uncoated region 12a may be formed at an end of a second side of the negative electrode 12 along a length direction of the negative electrode 12. The positive electrode 11 and the negative electrode 12 may be, e.g., spirally wound with the separator 13 (an insulator) therebetween.

However, the embodiments disclosed herein may use another suitable electrode assembly 10, e.g., a structure in which the positive electrode and the negative electrode are made of a plurality of sheets stacked with the separator therebetween.

The case 30 may be formed to be, e.g., a cuboid, and an opening may be formed at one side thereof.

A cap assembly 20 may include the cap plate 25 for covering the opening of the case 30, the positive terminal 21 that may protrude outside the cap plate 25 and may be electrically connected to the positive electrode 11, the negative terminal 22 that may protrude outside the cap plate 25 and may be electrically connected to the negative electrode 12, and a vent member 27 which may include a notch formed so as to be broken according to a predetermined internal pressure.

The cap plate 25 may be made of, e.g., a thin metal plate and may be fixed to the opening of the case 30 through, e.g., welding. An electrolyte injection opening for injecting an electrolyte solution may be formed at a first side of the cap plate 25, and a sealing cap 23 for sealing the electrolyte injection opening may be fixed to the cap plate 25.

The positive terminal 21 may pass through the cap plate 25, a first gasket 24 may be provided on the top and a second gasket 26 may be provided on the bottom and the first and second gaskets 24 and 26 may insulate the cap plate 25 from the positive terminal 21 by being between the cap plate 25 and the positive terminal 21.

The positive terminal 21 may be formed to have, e.g., a circular cylinder shape, a bottom nut 28 for supporting the positive terminal 21 at the top may be installed at the positive terminal 21, and a screw thread may be formed at an external circumference of the positive terminal 21 so that the bottom nut 28 may be fastened thereto.

The positive terminal 21 may be electrically connected to the positive uncoated region 11 a with a current collecting member 43 as a medium (e.g., in between), and a terminal flange for supporting the positive terminal 21 and the current collecting member 43 may be formed at the end of the positive terminal 21.

The negative terminal 22 may be provided to pass through the cap plate 25, and the first gasket 24 may be provided at the top and the second gasket 26 may be provided at the bottom to insulate the cap plate 25 from the negative terminal 22 by being between the cap plate 25 and the negative terminal 22.

The negative terminal 22 may be formed to have a circular cylinder shape, a bottom nut 28 for supporting the negative terminal 22 may be formed at the top of the negative terminal 22, and a screw thread may be formed at the external circumference of the negative terminal so that the bottom nut 28 may be fastened thereto.

The negative terminal 22 may be electrically connected to the negative uncoated region 12a with a current collecting member 44 as a medium (i.e., in between), and a terminal flange for supporting the negative terminal 22 and the current collecting member 44 may be formed at the bottom of the negative terminal 22.

As shown in FIG. 1 to FIG. 3, an injection hole 59 may be formed in the cap plate 25, and a gas supply pipe 51 may be inserted into the injection hole 59. The gas supply pipe 51 may connect the rechargeable battery 101 and the gas supply unit 61 to supply the inert gas into the case 30 of the rechargeable battery 101.

A sealing member 52 may be installed between the gas supply pipe 51 and the cap plate 25. The sealing member 52 may be made of, e.g., elastic rubber, silicon, and the like.

A valve 54 that controls the supply of the inert gas may be installed in the gas supply pipe 51. The valve 54 may be connected to the gas supply pipe 51 to control the supply of the inert gas, and thus it may supply the inert gas to the rechargeable battery 101 when the valve 54 is opened.

The gas supply unit 61 may be, e.g., a tank that stores the inert gas including, e.g., at least one material of helium, neon, argon, krypton, xenon, radon, and/or nitrogen, and the like.

A battery management system (BMS) 62 that controls opening and closing of the valve 54 may be connected to the valve 54. The battery management system 62 may be connected to a measurer 57 installed in the rechargeable battery 101 and may receive information on a state of the rechargeable battery 101 from the measurer 57. The measurer 57 may include at least one of a thermometer, a pressure gauge, and/or an impact detecting sensor, and the like.

When the rechargeable battery 101 is overheated or the internal pressure of the rechargeable battery 101 is increased (e.g., because of an abnormal reaction of the rechargeable battery 101), the measurer 57 may transmit information on the rechargeable battery 101 to a battery management system 72, and the battery management system 62 may open the valve 54 connected to the rechargeable battery 101 (i.e., the rechargeable battery that generated the abnormal reaction). The battery management system 72 may open the valve 54 based on the information transmitted by the measurer 57. The inert gas may be supplied (e.g., injected) into rechargeable battery 101 through the opened valve 54, and thus may increase safety of the rechargeable battery 101. Further, when an impact is applied to the rechargeable battery 101, the impact detecting sensor may detect the application of impact and may transmit information to the battery management system 62, which may cause the inert gas to be supplied (e.g., injected) to the impact-applied rechargeable battery 101.

When the inert gas is supplied (e.g., injected) into the rechargeable battery 101, air density and/or concentration inside the rechargeable battery 101 may be reduced, and thus may substantially prevent ignition, e.g., at a relatively high temperature. Also, when ignition occurs, a blaze may be extinguished by a substantial lack of oxygen.

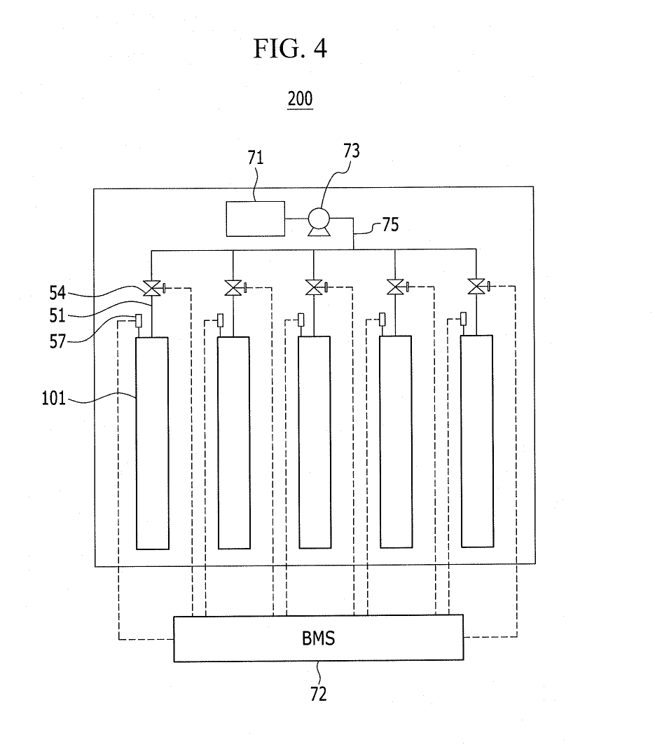

FIG. 4 illustrates a schematic diagram of a battery module according to a second exemplary embodiment.

Referring to FIG. 4, the battery module 200 may include a plurality of rechargeable batteries 101, a gas supply unit 71 that supplies the inert gas to the rechargeable batteries 101, and a gas supply pipe 51 connecting the rechargeable batteries 101 and the gas supply unit 71.

In the battery module 200, the rechargeable batteries 101 may be coupled (e.g., electrically connected) in series. However, the rechargeable batteries 101 may also be coupled (e.g., electrically connected) in parallel.

The rechargeable battery according to the present exemplary embodiment may have the same configuration as the rechargeable battery according to the first exemplary embodiment, and a description thereof will not be repeated.

The gas supply unit 71 may include a tank that stores the inert gas, e.g., an inert gas including at least one material selected from among helium, neon, argon, krypton, xenon, radon, and/or nitrogen, and the like.

The gas supply pipe 51 may be connected to each rechargeable battery 101, and the gas supply pipe 51 may be connected to the gas supply unit 71 with a confluence pipe 75 as a medium (e.g., in between). The confluence pipe 75 may be connected to each gas supply pipe 51 and may supply the inert gas to each gas supply pipe 51.

A pump 73 that pressurizes and supplies the inert gas may be installed in the confluence pipe 75. The pump 73 may be, e.g., a volumetric pump.

Valves 54 that control the supply of the inert gas may be installed in the gas supply pipes 51. The valves 54 may be connected to each gas supply pipe 51 to control the supply of the inert gas, and thus the respective valves 54 may individually supply the inert gas to the individually rechargeable batteries 101 when each valve 54 is opened.

A battery management system (BMS) 62 that controls opening and closing of the valves 54 may be connected to the valves 54. The battery management system 62 may be connected to the measurer 57 installed in the rechargeable battery 101 and may receive information on a state of the rechargeable battery 101 from the measurer 57. The measurer 57 may include at least one selected from among the thermometer, the pressure gauge, and/or the impact detecting sensor, and the like.

When the rechargeable battery 101 overheats or the internal pressure of the rechargeable battery 101 increases because of an abnormal reaction, the measurer 57 may transmit information on the rechargeable battery 101 to the battery management system 72, and the battery management system 62 may open the valve 54 that is connected to the rechargeable battery 101 having generated the abnormal reaction. The inert gas may be supplied (e.g., injected) to the rechargeable battery 101 with the valve 54 that is opened, and thus may improve the safety of the rechargeable battery 101. Also, when an impact is applied to the rechargeable battery 101, the impact detecting sensor may detect the application of impact and may transmit information to the battery management system 62, which may supply (e.g., inject) the inert gas into the impact-applied rechargeable battery 101.

When the inert gas is supplied (e.g., injected) into the rechargeable battery 101, the air density/concentration inside the rechargeable battery 101 may be reduced, and thus ignition (e.g., at a relatively high temperature) may be substantially prevented. Also, when an ignition is generated, a blaze may be extinguished by the substantial lack of oxygen.

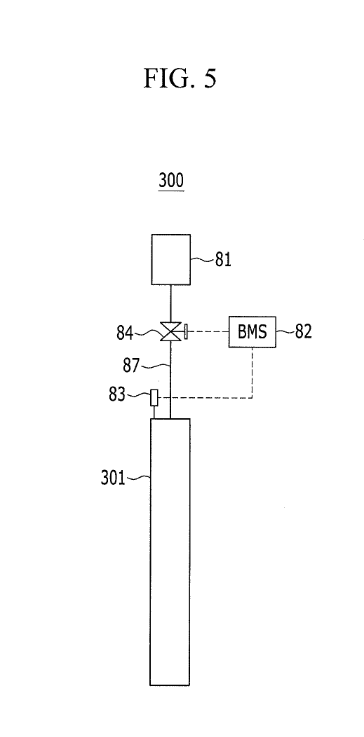

FIG. 5 illustrates a schematic diagram of a rechargeable battery pack according to a third exemplary embodiment.

Referring to FIG. 5, the rechargeable battery pack 300 according to the third exemplary embodiment may include a rechargeable battery 301, a gas supply unit 81 that supplies the inert gas to the rechargeable battery 301, a gas supply pipe 87 connecting the rechargeable battery 301 and the gas supply unit 81, and a battery management system 82 that controls the supply of the inert gas to the rechargeable battery 301.

The rechargeable battery pack 300 may include the rechargeable battery 301 and an additional material installed in the rechargeable battery 301 to provide improved safety to the rechargeable battery 301.

The rechargeable battery 301 may have the same configuration as the rechargeable battery according to the first exemplary embodiment, and thus a detailed description thereof will not be repeated.

The gas supply unit 81 may be connected to a tank in which the inert gas is stored, and the inert gas may include at least one material selected from among helium, neon, argon, krypton, xenon, radon, and/or nitrogen, and the like.

The gas supply pipe 87 may be connected to the rechargeable battery 301 and the gas supply unit 81, and may supply the inert gas of the gas supply unit 81 to the rechargeable battery 301

A valve 84 that controls the supply of the inert gas may be installed in the gas supply pipe 87.

The valve 84 may be connected to the battery management system (BMS) 82 that controls opening and closing of the valve 84. The battery management system 82 may be connected to a measurer 83 installed in the rechargeable battery 301 and may receive information on a state of the rechargeable battery 301 from the measurer 83. The measurer 83 may include at least one selected from among the thermometer, the pressure gauge, and/or the impact detecting sensor, and the like.

When the rechargeable battery 301 is overheated or the internal pressure of the rechargeable battery 301 is relatively increased (e.g., because of an abnormal reaction), the measurer 83 may transmit information on the rechargeable battery 301 to the battery management system 82, and the battery management system 82 may open the valve 84 that is connected to the rechargeable battery 301 having generated the abnormal reaction. The inert gas may be supplied (e.g., injected) to the rechargeable battery 301 with the valve 84 that is opened, and thus may increase the safety of the rechargeable battery 301. Also, when an impact is applied to the rechargeable battery 301, the impact detecting sensor may detect the application of the impact and may transmit information to the battery management system 82, with may cause the inert gas to be supplied (e.g., injected) into the impact-applied rechargeable battery 301.

By way of summary and review, a rechargeable battery may be used as a single-cell battery, e.g., in small electronic devices and the like, or as a battery module where a plurality of cells are electrically connected, e.g., in a motor-driving power source and the like. The rechargeable battery module may be formed by connecting electrode terminals of the cells through, e.g., a bus bar.

A rechargeable battery may explode or ignite when an abnormal reaction causes the pressure in the case to increase, e.g., because of an overcharge when the rechargeable battery module is charged and discharged. However, the rechargeable battery module described above may include a gas supply unit that supplies the inert gas to the rechargeable battery/batteries, and thus may substantially prevent or control explosions or ignition, thereby providing the battery module with improved safety. The battery module may supply the inert gas to the rechargeable battery/batteries when the abnormal reaction is detected. The battery module may supply the inert gas to only the rechargeable battery/batteries having the abnormal reaction.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of rechargeable batteries, each of the plurality of rechargeable batteries having a terminal;
a connecting member electrically connecting terminals of neighboring rechargeable batteries; and
a gas supply unit that supplies inert gas to the rechargeable batteries.

2. The battery module as claimed in claim 1, further comprising:
a valve provided between the gas supply unit and the rechargeable batteries, the valve controlling a supply of the inert gas.

3. The battery module as claimed in claim 2, wherein the gas supply unit is connected to the rechargeable batteries through a gas supply pipe.

4. The battery module as claimed in claim 3, wherein each of the rechargeable batteries includes a case forming an enclosure and a cap plate included with the case, and the inert gas is injected into the case.

5. The battery module as claimed in claim 4, wherein the gas supply pipe is installed in the cap plate.

6. The battery module as claimed in claim 5, further comprising:
a sealing member provided between the gas supply pipe and the cap plate.

7. The battery module as claimed in claim 6, wherein a plurality of gas supply pipes are connected to the gas supply unit through a confluence pipe.

8. The battery module as claimed in claim 7, further comprising:
a pump that pressurizes and supplies the inert gas, the pump being installed in the confluence pipe.

9. The battery module as claimed in claim 1, wherein:
the inert gas includes at least one material selected from among the group of helium, neon, argon, krypton, xenon, radon, and nitrogen.

10. The battery module as claimed in claim 2, further comprising:
a battery management system (BMS) connected to the valve, the battery management system controlling opening and closing of the valve.

11. The battery module as claimed in claim 10, further comprising:
a measurer installed in each of the rechargeable batteries, the measurer including at least one from the group of a thermometer, a pressure gauge, and an impact detecting sensor.

12. The battery module as claimed in claim 11, wherein:
the battery management system (BMS) is connected to the measurer, and uses information provided by the measurer to control opening and closing of the valve.

13. The battery module as claimed in claim 10, wherein:
the battery management system (BMS) independently controls the supply of the inert gas to a first rechargeable battery and the supply of the inert gas to a second rechargeable battery.

14. A rechargeable battery pack, comprising:
a rechargeable battery, the rechargeable battery including a case;
a gas supply unit that supplies inert gas into the case;
a valve provided between the gas supply unit and the rechargeable battery, the valve controlling a supply of the inert gas; and
a battery management system (BMS) that controls opening and closing of the valve.

15. The rechargeable battery pack as claimed in claim 14, wherein:
the gas supply unit is connected to the rechargeable battery through a gas supply pipe.

16. The rechargeable battery pack as claimed in claim 15, further comprising:
a cap plate included with the case, wherein the gas supply pipe is installed in the cap plate.

17. The rechargeable battery pack as claimed in claim 16, further comprising:
a sealing member installed between the gas supply pipe and the cap plate.

18. The rechargeable battery pack as claimed in claim 14, further comprising:
a measurer installed in the rechargeable battery, the measurer including at least one selected from among the group of a thermometer, a pressure gauge, and an impact detecting sensor.

19. The rechargeable battery pack as claimed in claim 18, wherein:
the battery management system (BMS) is connected to the measurer, and uses information provided by the measurer to control opening and closing of the valve.
